(19) United States
(12) Patent Application Publication
(10) Pub. No.: US 2005/0129591 A1
(43) Pub. Date: Jun. 16, 2005

(54) Bifunctional layered photocatalyst/thermocatalyst for improving indoor air quality

(76) Inventors: Di Wei, Manchester, CT (US); Thomas H. Vanderspurt, Glastonbury, CT (US); Stephen O. Hay, South Windsor, CT (US); Wayde R. Schmidt, Pomfret Center, CT (US); Timothy N. Obee, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/736,922

(22) Filed: Dec. 16, 2003

(51) Int. Cl. B01J 19/08

(52) U.S. Cl. 422/186

(57) ABSTRACT

A photocatalytic/thermocatalytic coating includes an inner layer of metal/titanium dioxide or metal oxide/titanium dioxide that is applied on a honeycomb and an outer layer of titanium dioxide or metal oxide doped titanium dioxide applied on the inner layer. The inner layer of can be gold/titanium dioxide, platinum/titanium dioxide, or manganese oxide/titanium dioxide. The outer layer of titanium dioxide or metal oxide doped titanium dioxide oxides volatile organic compounds to carbon dioxide, water, and other substances. As the outer layer is thin and porous, the contaminants in the air can diffuse through the outer layer and adsorb onto the inner layer. When photons of the ultraviolet light are absorbed by the coating, reactive hydroxyl radicals are formed that oxidize the contaminant to produce water, carbon dioxide, and other substances.

### BACKGROUND OF THE INVENTION

The present invention relates generally to a photocatalyst/thermocatalyst including an inner layer of metal/titanium dioxide or metal oxide/titanium dioxide and an outer layer of titanium dioxide or metal oxide/titanium dioxide that oxidizes gaseous contaminants in the air that adsorb onto the photocatalytic/thermocatalytic surface to form carbon dioxide, water, and other substances.

Indoor air can include trace amounts of contaminants, including carbon monoxide, ozone and volatile organic compounds such as formaldehyde, toluene, propanal, butene, and acetaldehyde. Absorbent air filters, such as activated carbon, have been employed to remove these contaminants from the air. As air flows through the filter, the filter blocks the passage of the contaminants, allowing contaminant free air to flow from the filter. A drawback to employing filters is that they simply block the passage of contaminants and do not destroy them. Additionally, the filter is not effective in blocking ozone and carbon monoxide.

Titanium dioxide has been employed as a photocatalyst in an air purifier to destroy contaminants. When the titanium dioxide is illuminated with ultraviolet light, photons are absorbed by the titanium dioxide, promoting an electron from the valence band to the conduction band, thus producing a hole in the valence band and adding an electron in the conduction band. The promoted electron reacts with oxygen, and the hole remaining in the valence band reacts with water, forming reactive hydroxyl radicals. When a contaminant adsorbs onto the titanium dioxide catalyst, the hydroxyl radicals attack and oxidize the contaminants to water, carbon dioxide, and other substances.

Doped or metal oxide treated titanium dioxide can increase the effectiveness of the titanium dioxide photocatalyst. However, titanium dioxide and doped titanium dioxide are less effective or not effective in oxidizing carbon monoxide. Carbon monoxide (CO) is a colorless, odorless, and poisonous gas that is produced by the incomplete combustion of hydrocarbon fuels. Carbon monoxide is responsible for more deaths than any other poison and is especially dangerous in enclosed environments. Gold can be loaded on the titanium dioxide to act as an effective thermocatalyst for the room temperature oxidation of carbon monoxide to carbon dioxide.

Photocatalytically, titanium dioxide alone is less effective in decomposing ozone. Ozone (O₃) is a pollutant that is released from equipment commonly found in the workplace, such as copiers, printer, scanners, etc. Ozone can cause nausea and headaches, and prolonged exposure to ozone can damage nasal mucous membranes, causing breathing problems. OSHA has set a permissible exposure limit (PEL) to ozone of 0.08 ppm over an eight hour period.

Ozone is a thermodynamically unstable molecule and decomposes very slowly up to temperatures of 250° C. At ambient temperatures, manganese oxide is effective in decomposing ozone by facilitating the oxidation of ozone to adsorbed surface oxygen atoms. These adsorbed oxygen atoms then combine with ozone to form an adsorbed peroxide species that desorbs as molecular oxygen.

Hence, there is a need for catalyst that oxidizes and decomposes gaseous contaminants, including volatile organic compounds, carbon monoxide and ozone, that adsorb onto the photocatalytic surface to form carbon dioxide, water, oxygen and other substances.

### SUMMARY OF THE INVENTION

A layered photocatalytic/thermocatalytic coating on a substrate purifies the air in a building or a vehicle by oxidizing or decomposing contaminants that adsorb onto the coating to water, oxygen, carbon dioxide, and other substances.

A fan draws air into an air purification system. The air flows through an open passage or channel of a honeycomb. The surface of the honeycomb is coated with a layered photocatalytic/thermocatalytic coating. An ultraviolet light source positioned between successive honeycombs activates the coating. The coating includes an inner layer of a metal/titanium dioxide or metal oxide/titanium dioxide coating and an outer layer of a titanium dioxide or metal oxide/titanium dioxide coating.

In one example, the inner layer is gold/titanium dioxide. At room temperature, the inner layer of gold/titanium dioxide oxidizes carbon monoxide to carbon dioxide. When carbon monoxide adsorbs on the gold/titanium dioxide coating, the gold acts as an oxidation catalyst and lowers the energy barrier of the oxidation of carbon monoxide to carbon dioxide in the presence of oxygen.

In another example, the inner layer is manganese oxide/titanium dioxide. At room temperature, the manganese oxide/titanium dioxide coating decomposes ozone to oxygen. When ozone adsorbs on the coating, the manganese oxide lowers the energy barrier required for ozone decomposition, decomposing the ozone to molecular oxygen.

In another example, the inner layer is platinum/titanium dioxide. At room temperature, the platinum/titanium dioxide coating oxidizes low polarity organic compounds to carbon dioxide. Low polarity organic compounds have an increased affinity to platinum. The low polarity organic compounds adsorb onto the platinum and are oxidized by the hydroxyl radicals to carbon dioxide and water in the presence of oxygen.

The outer layer oxidizes volatile organic compounds to carbon dioxide, water and other substances. The outer layer is thin, porous and not opaque to ultraviolet light. Therefore, carbon monoxide, ozone and low polarity organic compounds can diffuse through the outer layer and absorb on the metal/titanium dioxide or metal oxide/titanium dioxide inner layer for catalysis. Additionally, the outer layer allows the ultraviolet light to penetrate and reach the inner layer.

When photons of the ultraviolet light are absorbed by the coating, reactive hydroxyl radicals are formed. When a contaminant is adsorbed onto the coating, the hydroxyl radical attacks the contaminant, abstracting a hydrogen atom from the contaminant and oxidizing the volatile organic compounds to water, carbon dioxide, and other substances.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates an enclosed environment, such as a building, vehicle or other structure, including an interior space and an HVAC system;

FIG. 2 schematically illustrates the air purification system of the present invention;

FIG. 3 schematically illustrates the honeycomb of the air purification system;

FIG. 4 schematically illustrates the coating of the present invention;

FIG. 5 schematically illustrates an alternate application of the coating of the present invention;

FIG. 6 schematically illustrates an alternate embodiment of the air purification system employing two honeycombs each with a different coating;

FIG. 7 schematically illustrates an another alternate embodiment of the air purification system employing two honeycombs each with a different coating;

FIG. 8 schematically illustrates adjacent honeycombs of the air purification system of the present invention;

FIG. 9 schematically illustrates adjacent honeycombs of the air purification system of the present invention that are bonded together by an adhesive or attachment mechanism; and

FIG. 10 schematically illustrates another alternate orientation of the honeycombs of the air purification system of the present invention.

### DETAILED DESCRIPTION OF THE PREFERRED EMBODIMENT

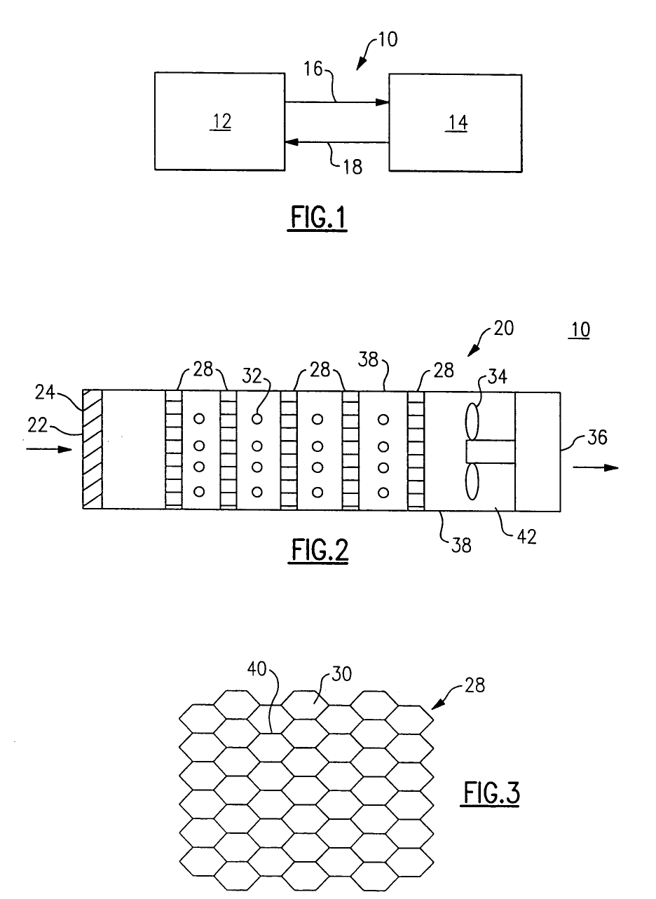

FIG. 1 schematically illustrates a building, vehicle, or other structure 10 including an interior space 12, such as a room, an office or a vehicle cabin, such as a car, train, bus or aircraft. An HVAC system 14 heats or cools the interior space 12. Air in the interior space 12 is drawn by a path 16 into the HVAC system 14. The HVAC system 14 changes the temperature of the air drawn 16 from the interior space 12. If the HVAC system 14 is operating in a cooling mode, the air is cooled. Alternately, if the HVAC system 14 is operating in a heating mode, the air is heated. The air is then returned back by a path 18 to the interior space 12, changing the temperature of the air in the interior space 12.

FIG. 2 schematically illustrates an air purification system 20 employed to purify the air in the building or vehicle 10 by oxidizing contaminants, such as volatile organic compounds, semi-volatile organic compounds, carbon monoxide and ozone, in the air to water, carbon dioxide, and other substances. For example, the volatile organic compounds can be aldehydes, ketones, alcohols, aromatics, alkenes, alkanes or mixtures thereof. The air purification system 20 can purify air before it is drawn along path 16 into the HVAC system 14 or it can purify air leaving the HVAC system 14 before it is blown along path 18 into the interior space 12 of the building or vehicle 10. The air purification system 20 can also be a stand alone unit that is not employed with a HVAC system 14.

A fan 34 draws air into the air purification system 20 through an inlet 22. The air flows through a particle filter 24 that filters out dust or any other large particles by blocking the flow of these particles. The air then flows through a substrate 28, such as a honeycomb. In one example, the honeycomb 28 is made of aluminum or an aluminum alloy. FIG. 3 schematically illustrates a front view of the honeycomb 28 having a plurality of hexagonal open passages or channels 30. The surfaces of the plurality of open passages 30 are coated with a photocatalytic/thermocatalytic coating 40. When activated by ultraviolet light, the coating 40 oxidizes volatile organic compounds that adsorb onto the coating 40. As explained below, as air flows through the open passages 30 of the honeycomb 28, contaminants that are adsorbed on the surface of the coating 40 are oxidized into carbon dioxide, water and other substances.

A light source 32 positioned between successive honeycombs 28 activates the photocatalytic coating 40 on the surface of the open passages 30. As shown, the honeycombs 28 and the light source 32 alternate in the air purification system 20. That is, there is a light source 32 located between each of the honeycombs 28. Preferably, the light source 32 is an ultraviolet light source which generates light having a wavelength in the range of 180 nanometers to 400 nanometers.

The light source 32 is illuminated to activate the coating 40 on the surface of the honeycomb 28. When the photons of the ultraviolet light are absorbed by the coating 40, an electron is promoted from the valence band to the conduction band, producing a hole in the valence band. The coating 40 must be in the presence of oxygen and water to oxidize the contaminants into carbon dioxide, water, and other substances. The electrons that are promoted to the conduction band are captured by the oxygen. The holes in the valence band react with water molecules adsorbed on the photocatalytic/thermocatalytic coating 40 to form reactive hydroxyl radicals.

When a contaminant is adsorbed onto the coating 40, the hydroxyl radical attacks the contaminant, abstracting a hydrogen atom from the contaminant. In this method, the hydroxyl radical oxidizes the contaminants and produces water, carbon dioxide, and other substances.

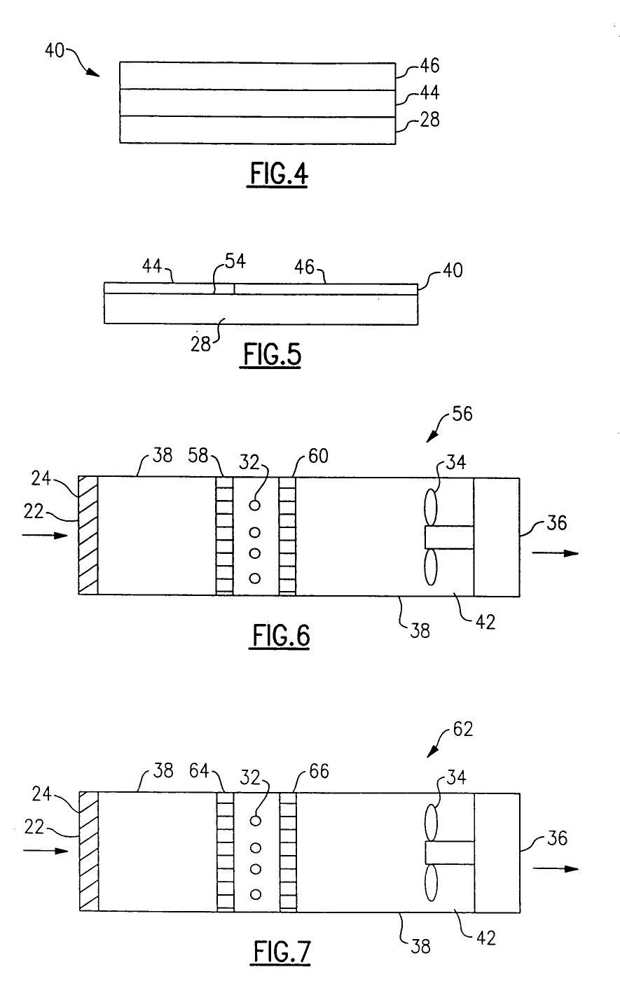

As shown in FIG. 4, the coating 40 includes an inner layer 44 of a metal/titanium dioxide or metal compound/titanium dioxide thermocatalyst/photocatalyst applied on the honeycomb 28 and an outer layer 46 of a titanium dioxide or metal compound/titanium dioxide photocatalyst applied on the inner layer 44. Preferably, the metal compound/titanium dioxide of the inner layer 44 and the outer layer 46 are metal oxide/titanium dioxide.

The outer layer of titanium dioxide 46 or metal oxide/titanium dioxide is effective in oxidizing volatile organic compounds and semi-volatile organic compounds to carbon dioxide, water and other substances. The outer layer 46 has an effective thickness and porosity. That is, the outer layer 46 is able to allow other contaminants that are not oxidized by the outer layer 46, such as carbon monoxide, to pass through the outer layer 46 and adsorb on the inner layer 44. In one example, the outer layer 46 is visibly white and not opaque to ultraviolet light.

Preferably, the photocatalyst is titanium dioxide. In one example, the titanium dioxide is Millennium titania, Degussa P-25, or an equivalent titanium dioxide. However, it is to be understood that other photocatalytic materials or a combination of titanium dioxide with other metal oxides can be employed. For example, the photocatalytic materials can be Fe₂O₃, ZnO, V₂O₅, SnO₂, FeTiO₃ or mixtures thereof.

Additionally, one or more of other metal oxides can be mixed with titanium dioxide, such as Fe₂O₃, ZnO, V₂O₅, SnO₂, CuO, MnOx, WO₃, CO₃O₄, CeO₂, ZrO₂, SiO₂, Al₂O₃, Cr₂O₃, or NiO.

Additionally, if the outer layer 46 is a metal oxide loaded titanium dioxide, the titanium dioxide can be doped with one or more of WO₃, ZnO, SrTiO₃, Fe₂O₃, V₂O₅, SnO₂, FeTiO₃, PbO, CO₃O₄, NiO, CeO₂, CuO, SiO₂, Al₂O₃, MnO₂, Cr₂O₃, or ZrO₂. Alternately, the titanium dioxide can be loaded with any photocatalytic material, such as CdS or CdSe.

In one example, the outer layer 46 has a thickness of less than 2 μm of titanium dioxide or metal oxide doped titanium dioxide that is applied over the inner layer 44. The outer layer 46 can be applied to the surface of the inner layer 44 by spraying, electrophoresis, dip coating, or an alternate suitable method of deposition. In one example, a 25% weight aqueous suspension of photocatalyst is prepared. The suspension can be sprayed on the substrate coated with the inner layer 44. After the suspension is applied, the substrate is allowed to dry, forming a uniform outer layer 46 on the inner layer 44 on the honeycomb 28.

In a first example, the inner layer 44 is gold/titanium dioxide. At room temperature, the inner layer 44 oxidizes carbon monoxide to carbon dioxide. When carbon monoxide adsorbs on the coating, the gold/titanium dioxide acts as a thermal catalyst and lowers the energy barrier of the carbon monoxide, oxidizing the carbon monoxide to carbon dioxide in the presence of oxygen. Titanium dioxide is an effective support for low temperature carbon monoxide oxidation. Additionally, gold/titanium dioxide is an effective photocatalyst to oxidize volatile organic compounds that diffuse through the outer layer 46 to water and carbon dioxide. Therefore, the inner layer 44 acts simultaneously as both a photocatalyst and a thermocatalyst.

Carbon monoxide oxidation occurs mainly on the perimeter interface of the gold particles. Carbon monoxide is adsorbed on either surface or perimeter sites of the gold to form carbonyl species. Oxygen is adsorbed on the gold/titanium dioxide surface. It is believed that the oxygen is adsorbed onto the perimeter interface. The carbonyl species on the perimeter sites react with the oxygen, forming an oxygen-gold-carbon monoxide complex. The complex is decomposed to produce carbon dioxide.

In the case of photocatalytic function, the highly dispersed gold particles on the surface of the titanium dioxide reduce the recombination rate of the electrons and the holes in the inner layer 44, increasing the photocatalytic activity of the coating. Preferably, the gold particles have a size less than 3 nanometers. For the thermocatalytic function, the size of the gold particles is also critical to the activity of the carbon monoxide oxidation, which is dependent on the gold being formed into very small nano-particles.

The catalytic performance of the gold/titanium dioxide coating is influenced by the preparation method. The catalytic activity of gold is dependent on the gold being formed into nano-particles. The nano-particles of gold can be generated by any method, including co-precipitation, deposition-precipitation, liquid phase grafting, colloidal mixing, impregnation, or chemical vapor deposition.

In the co-precipitation method, a catalyst is prepared by mixing an aqueous solution of gold precursor and an aqueous solution of titanium precursor at room temperature or at a slightly elevated temperature and at a constant pH. The precipitate is filtered and washed thoroughly with distilled water and is dried at 70° C. under vacuum overnight. After drying, the product is calcined at a range of 200° C. to 500° C. form a dried gold/titanium dioxide photocatalyst/thermocatalyst.

In the deposition-precipitation method, titanium dioxide powder is suspended in distilled water a desired amount of HAuCl₄. Urea is added slowly to the mixture, and the mixture is then heated to 80° to 90° C., decomposing the urea to release NH₄OH (ammonium hydroxide) and carbon dioxide, thus increasing the pH of the mixture. The slow increase in pH induces homogeneous precipitation of Au(OH)₃ onto the surface of the titanium dioxide. The sample is washed thoroughly in distilled water to remove residual chloride ions. The sample is then dried at 70° C. under vacuum overnight. The sample is then calcined at temperatures from 200° C. to 500° C. to form a dried gold/titanium dioxide photocatalyst/thermocatalyst. An advantage to the deposition-precipitation method is that all of the active components remain on the surface of the titanium dioxide support and are not buried within it.

In liquid phase grafting method, a gold complex in solution reacts with the surface of a support, such as titanium dioxide, forming species convertible to a catalytically active form. Me₂Au can be used as a gold precursor. The precursor is dissolved into acetone and then titanium dioxide is added to the solvent. This mixture is allowed to settle so that the gold precursor adsorbs onto the metal oxide surface. The mixture is then filtered and calcined at 400° C. for 4 hours.

In one example, to coat the bifunctional catalyst on the honeycomb 28, water is added to the dried gold/titanium dioxide photocatalyst/thermocatalyst to form an aqueous 25% weight suspension. The suspension is applied to the surface of the honeycomb 28 by spraying, electrophoresis, or dip coating to form the gold/titanium dioxide inner layer 44. After the suspension is applied, the substrate is allowed to dry, forming a uniform gold/titanium dioxide inner layer 44 on the honeycomb 28.

Before the gold/titanium dioxide suspension is applied to the honeycomb 28, the suspension can be treated to increase its adhesion to the honeycomb 28. For example, the suspension can be homogenized by using a homogenizer with a dispersing generator at a speed of 7500 rpm. When the suspension is applied to the honeycomb 28, the coating is porous on a nanometer scale and usually has a surface area greater than 40 m²/g. The inner layer 44 is then allowed to dry on the honeycomb 28. The inner layer 44 can also be heated to an effective temperature.

The titanium dioxide can also be loaded with a metal oxide to further improve the photocatalytic and thermocatalytic effectiveness of the gold/titanium dioxide inner layer 44. Gold has a tendency to migrate on the surface of the titanium dioxide to form large clusters. The effectiveness of the gold/titanium dioxide inner layer 44 can be reduced due to the migration of gold particles. By loading a metal oxide on the surface of the titanium dioxide, the metal oxide can separate the gold particles and prevent them from migrating and forming large clusters, therefore increasing the effectiveness of the gold/titanium dioxide inner layer 44. Preferably, a metal oxide is employed to immobilize the gold particles on the surface of the titanium dioxide. In one example, the metal oxide is one or more of WO₃, ZnO, CdS, SrTiO₃, Fe₂O₃, V₂O₅, SnO₂, FeTiO₃, PbO, CeO₂, CuO, Sio₂, Al₂O₃, MnOx, Cr₂O₃, or ZrO₂.

In another example, the inner layer 44 is platinum/titanium dioxide. At room temperature, the inner layer 44 oxidizes low polarity organic compounds to carbon dioxide simultaneously with oxidation of harmful volatile organic compounds. Low polarity organic molecules have an in creased affinity to platinum. When low polarity organic compounds adsorbs on the platinum, the platinum retains the low polarity organic compounds on the inner layer 44 oxidation by the hydroxyl radicals, oxidizing the low polarity organic compounds to carbon dioxide in the presence of oxygen.

Platinum dispersed on titanium dioxide exhibits photocatalytic behavior for low contaminant concentrations, such as below 50 ppm. The photocatalytic oxidation rate of ozone, ethylene and butane is greater for platinum on titanium dioxide that for titanium dioxide alone. The photocatalytic oxidation rate is double for ozone and butane and between 2 to 14 times for ethylene over platinum on titanium dioxide. The photocatalytic oxidation rate of ethylene depends on humidity and ethylene concentrations. Surprisingly, the photocatalytic oxidation of these contaminants increases with increasing water vapor. In contrast, the photocatalytic oxidation of contaminants with titanium dioxide alone decreases with increased humidity.

The highly dispersed platinum particles on the surface of the titanium dioxide reduce the recombination rate of the electrons and the holes, increasing the photocatalytic activity of the coating. Preferably, the platinum particles have a size less than 5 nanometers and form platinum islands of about 1.0-1.5 nanometers. The preferred platinum loading is between 0.1% and 5.0%.

In another example, the inner layer 44 is manganese oxide/titanium dioxide. Manganese oxide includes manganese dioxide and doped manganese oxide. At ambient temperatures, manganese oxide is effective in decomposing ozone. Manganese oxide facilitates the decomposition of ozone to adsorbed surface oxygen atoms. These oxygen atoms then combine with ozone to form an adsorbed peroxide species that desorbs as molecular oxygen. When ozone adsorbs on the manganese oxide, the manganese oxide acts as a site for dissociative ozone adsorption by lowering the energy barrier required for ozone decomposition. Therefore, in the presence of ozone alone, the manganese oxide produces oxygen.

Additionally, the peroxide species are highly reactive and assist in the oxidation of volatile organic compounds to carbon dioxide and water. Therefore, the manganese oxide can be highly effective in oxidizing volatile organic compounds. In the presence of volatile organic compounds alone, the manganese oxide inner layer 44 of the coating 40 produces carbon dioxide, water, and other substances. Therefore, the manganese dioxide photocatalytic/thermocatalytic coating acts simultaneously as both a photocatalyst and a thermocatalyst.

At room temperature, the manganese oxide/titanium dioxide inner layer 44 of the coating 40 decomposes ozone to oxygen simultaneously with oxidation of harmful volatile organic compounds to carbon dioxide, water, and other substances. Therefore, the manganese oxide/titanium dioxide photocatalytic/thermocatalytic coating acts simultaneously as both a photocatalyst and a thermocatalyst.

The highly dispersed manganese oxide particles on the surface of the titanium dioxide reduce the recombination rate of the electrons and the holes, increasing the photocatalytic activity of the coating. Preferably, the manganese oxide particles are nano-sized.

The catalytic performance of the manganese oxide/titanium dioxide coating is influenced by the preparation method. The nano-particles of manganese oxide can be generated by deposition-precipitation, co-precipitation, impregnation, or chemical vapor deposition. By employing these methods, nano-particles of manganese oxide can be generated, improving the catalytic activity.

To prepare the manganese oxide/titanium dioxide photocatalyst/thermocatalyst of the present invention, water is added drop-wise to powder titanium dioxide to determine the point at which the pores in the titanium dioxide are filled with water, or the point of incipient wetness. This amount of water is then used to dissolve a manganese salt (manganese nitrate or preferably manganese acetate). The amount of manganese salt needed is determined by the mole percentage of manganese targeted for the surface, usually 0.1 to 6 mol %.

The manganese salt solution is then added drop-wise to the titanium dioxide. The resulting powder is then dried at 120° C. for six hours. The powder is then calcined at 500° C. for six hours to remove the acetate and nitrate. During calcination, the manganese is oxidized to form manganese oxide. After calcination, a titanium dioxide powder layered with manganese oxide nano-particles is created.

To coat manganese oxide/titanium dioxide bifunctional catalyst to a substrate, water is added to the dried manganese oxide/titanium dioxide photocatalyst/thermocatalyst to form a suspension. The suspension is applied to the surface of the honeycomb 28 by spraying, electrophoresis, or dip coating to form the manganese oxide/titanium dioxide inner layer 44. After the suspension is applied, the suspension is allowed to dry, forming a uniform manganese oxide/titanium dioxide inner layer 44 on the honeycomb 28. Preferably, the suspension has weight 1% of manganese oxide on titanium dioxide.

When a metal is doped on titanium dioxide, the effective penetration depth of light is reduced. Therefore, it is desirable to locate the layer with the smaller effective penetration depth on the honeycomb 28 followed by the layer with the greater effective penetration depth of light. Therefore, the layer with the greatest effective penetration depth of light is closest to the light source 32. The inner layer 44 has a smaller effective penetration depth and is deposited on the honeycomb 28 first. The outer layer 46 has a greater effective penetration depth and is then deposited on the inner layer 44.

The thickness of the outer layer 46 (the layer with the greatest effective penetration depth) can be adjusted to absorb only part of the light from the light source 44, allowing some or none of the light to reach the inner layer 44. If none of the light from the light source 32 reaches the inner layer 44, the porosity of the outer layer 46 allows penetration of contaminants into the inner layer 44. Therefore, contaminants such as carbon monoxide can be oxidized and contaminants such as ozone can be decomposed on the inner layer 44. In this case, the inner layer 44 serves as a thermocatalyst only. If some of the ultraviolet light from the light source 32 reaches and is absorbed by the inner layer 44, the inner layer 44 can be bifunctional as a photocatalyst and a thermocatalyst. The outer layer 46 applied over the inner layer 44 is directly exposed to the ultraviolet light and can provide the photocatalytic activity to oxidize contaminants to carbon dioxide, water and other substances. Additionally, the outer layer 46 is porous to allow carbon monoxide, ozone, and low polarity organic compounds to pass through the outer layer 46 and adsorb onto the inner layer 44.

The inner layer 44 can be selected based on environment. If the air has a high concentration of ozone, manganese oxide/titanium dioxide can be used as the inner layer 44. Alternately, if the air has a high concentration of carbon monoxide, gold/titanium dioxide can be used as the inner layer 44.

After passing through the honeycombs 28, the purified air then exits the air purifier through an outlet 36. The walls 38 of the air purification system 20 are preferably lined with a reflective material 42. The reflective material 42 reflects the ultraviolet light onto the surface of the open passages 30 of the honeycomb 28.

FIG. 5 illustrates an alternate embodiment of the bifunctional coating 40 of the present invention. The coating 40 includes a layer 44 of a metal/titanium dioxide or metal compound/titanium dioxide thermocatalyst/photocatalyst applied on a portion of the surface 54 of the honeycomb 28 and a layer 46 of a titanium dioxide or metal compound/titanium dioxide photocatalyst applied on another portion of the surface 54 of the honeycomb 28.

In another embodiment, different coating formulations are placed on different substrates to increase the design flexibility of the system 20 and to change the overall effectiveness of the system 20.

FIG. 6 illustrates an alternate example of the air purification system 56. In this example, the air first flows through a first honeycomb 58 having a gold/titanium dioxide coating which performs as a bifunctional photocatalyst/thermocatalyst. Due to its thermocatalytic function, the gold/titanium dioxide coating can oxidize carbon monoxide to carbon dioxide. Simultaneously, due to its photocatalytic function, the gold/titanium dioxide coating can oxidize volatile organic compounds, particularly formaldehyde to carbon dioxide and water. The gold/titanium dioxide catalyst provides superior photocatalytic activity over titanium dioxide alone in formaldehyde oxidation.

The air then flows through a second honeycomb 60 having a metal oxide doped titanium dioxide coating. The metal oxide can be one or more of WO₃, ZnO, SrTiO₃, Fe₂O₃, V₂O₅, SnO₂, FeTiO₃, PbO, CO₃O₄, NiO, CeO₂, CuO, SiO₂, Al₂O₃, MnxO₂, Cr₂O₃, or ZrO₂. The metal oxide doped titanium dioxide coating on the second honeycomb 60 oxidizes the remaining contaminants from the first honeycomb 58, such as volatile organic compounds and semi-volatile organic compounds, to water and carbon dioxide. Volatile organic compounds are classified as compounds having boiling points less than approximately 200° C., and semi-volatile organic compounds are classified as compounds having boiling points at or above 200° C.

By employing a first honeycomb 58 with a gold/titanium dioxide coating and a second honeycomb 60 with a metal oxide doped titanium dioxide coating, both carbon monoxide, volatile organic compounds, and semi-volatile organic compounds can be oxidized and destroyed. Therefore, the air purification system 56 including the gold/titanium dioxide coated first honeycomb 58 and the metal oxide doped titanium dioxide coated second honeycomb 60 perform the same function as the layered coating 40 having the inner layer 44 of gold/titanium dioxide and the outer layer 46 of metal oxide doped titanium dioxide.

In this configuration, the order of the first honeycomb 58 and the second honeycomb 60 is critical to the performance of the air purification system 56. Compared to other volatile organic compound contaminants, formaldehyde has a relatively strong adsorption on the surface of titanium dioxide, covering the active sites that are otherwise available to other volatile organic compounds. Therefore, the removal of formaldehyde by the first honeycomb 58 significantly improves the photocatalytic activity of the second honeycomb 60 in the oxidation of other volatile organic compounds.

FIG. 7 illustrates an alternate example of the air purification system 62. In this example, the air first flows through a first honeycomb 64 having a metal oxide doped titanium dioxide coating. The metal oxide can be one or more of WO₃, ZnO, SrTiO₃, Fe₂O₃, V₂O₅, SnO₂, FeTiO₃, PbO, CO₃O₄, NiO, CeO₂, CuO, SiO₂, Al₂O₃, MnxO₂, Cr₂O₃, or ZrO₂. The metal oxide doped titanium dioxide coating on the first honeycomb 64 oxidizes contaminants, such as volatile organic compounds and semi-volatile organic compounds, to water and carbon dioxide. The air then flows through a second honeycomb 66 having a manganese oxide/titanium dioxide coating to decompose ozone to oxygen and water. By employing a first honeycomb 64 with a metal oxide doped titanium dioxide coating and a second honeycomb 66 with a manganese oxide/titanium dioxide coating, both ozone, volatile organic compounds, and semi-volatile organic compounds can be oxidized and destroyed. Therefore, the air purification system 62 including the metal oxide doped titanium dioxide coated first honeycomb 64 and the manganese oxide/titanium dioxide coated second honeycomb 66 perform the same function as the layered coating 40 having the inner layer 44 of manganese oxide/titanium dioxide and the outer layer 46 of metal oxide doped titanium dioxide.

In this configuration, ozone is a strong oxidation agent and will assist in the photocatalytic oxidation. Therefore, it is preferred that the air flows through the metal oxide doped titanium dioxide coated first honeycomb 64 before flowing through the manganese oxide/titanium dioxide coated second honeycomb 66. Alternately, the air purification system 62 includes more than one first honeycomb 64 and more than one second honeycomb 66.

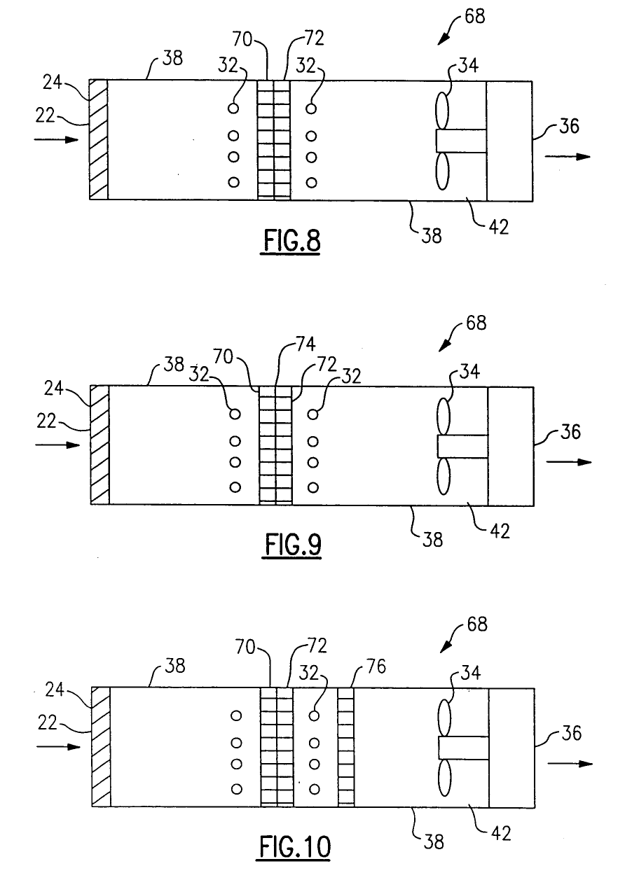

It is to be understood that alternates orientations of the honeycombs 58 and 60 of the air purification system 56 and the honeycombs 64 and 66 of the air purification system 62 are possible. As shown in FIG. 8, the air purification system 68 can include a first honeycomb 70 and a second honeycomb 72 located adjacent to each other in the air purification system 68. That is, there is no lamp or light source located between the honeycombs 70 and 72. Alternately, as shown in FIG. 9, the first honeycomb 70 and the second honeycomb 72 are attached or bonded together by an adhesive 74. Alternately, the first honeycomb 70 and the second honeycomb 72 are attached by an attachment mechanism. Additional honeycombs 76 can also be employed with the air purification system 62, as shown in FIG. 10. For example, the first honeycomb 70 and the second honeycomb 72 are positioned on one side of the light source 32 and an additional honeycomb 74 with a coating is positioned on the opposing side of the light source 32. Although only one additional honeycomb 76 is illustrated and described, it is to be understood that any number of additional honeycombs 76 can be employed.

As explained above, the first honeycomb 70 can have a gold/titanium dioxide coating and the second honeycomb 72 can have a metal oxide doped titanium dioxide coating. Alternately, the first honeycomb 70 can have a metal oxide doped titanium dioxide coating and the second honeycomb 72 can have a manganese oxide/titanium dioxide coating to decompose ozone to oxygen and water. The additional honeycomb 76 can have any coating that produces the desired purification effect, and one skilled in the art would know what coating to employ on the additional honeycomb 76.

Although a honeycomb 28 has been illustrated and described, it is to be understood that the coating 40 can be applied on any structure. The voids in a honeycomb 28 are typically hexagonal in shape and uniformly distributed, but it is to be understood that other void shapes and distributions can be employed. As contaminants adsorb onto the coating 40 of the structure in the presence of a light source, the contaminants are oxidized into water, carbon dioxide and other substances.

Additionally, a detailed description of coating processes are disclosed in co-pending patent application Ser. No. 10/449,752 filed May 30, 2003 entitled Tungsten Oxide/Titanium Dioxide Photocatalyst for Improving Indoor Air Quality, patent application Ser. No. 10/464,942 filed on Jun. 19, 2003 entitled Bifunctional Manganese Oxide/Titanium Dioxide Photocatalyst/Thermocatalyst for Improving Indoor Air Quality, and pending patent application Ser. No. 10/465,025 filed on Jun. 19, 2003 and entitled Bifunctional Gold/Titanium Dioxide Photocatalyst/Thermocatalyst for Improving Indoor Air Quality, the disclosures of which are incorporated by reference in its entirety. Related information on bifunctional manganese oxide/titanium dioxide photocatalyst/thermocatalyst is also disclosed in pending patent application Ser. No. 10/464,942. Related information on bifunctional gold/titanium dioxide photocatalyst/thermocatalyst is also disclosed in pending patent application Ser. No. 10/465,024.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A purification system comprising:
a substrate;
a layered catalytic coating including a first layer of one of metal/titanium dioxide and metal compound/titanium dioxide applied on said substrate and a second layer of one of titanium dioxide and metal compound/titanium dioxide applied on said first layer.

2. The purification system as recited in claim 1 wherein said first layer is gold on titanium dioxide and catalytically oxidizes carbon monoxide to carbon dioxide and water.

3. The purification system as recited in claim 1 wherein said first layer is platinum/titanium dioxide and catalytically oxidizes low polarity organic compounds to carbon dioxide and water.

4. The purification system as recited in claim 3 wherein said first layer includes platinum on titanium dioxide, and said platinum has an increased affinity for said low polarity organic compounds, said low polarity organic compounds adsorb onto said platinum, and said hydroxyl radicals oxidize said low polarity organic compounds to carbon dioxide.

5. The purification system as recited in claim 1 wherein said first layer is manganese oxide/titanium dioxide and decomposes ozone.

6. The purification system as recited in claim 5 wherein said first layer includes manganese oxide on titanium dioxide, and said manganese oxide lowers an energy barrier of decomposition of said ozone to decompose said ozone to molecular oxygen.

7. The purification system as recited in claim 1 further including a light source to activate said layered catalytic coating, and said layered catalytic coating oxidizes contaminants in an air flow that are adsorbed onto said layered catalytic coating when activated by said light source.

8. The purification system as recited in claim 7 wherein said light source is an ultraviolet light source.

9. The purification system as recited in claim 7 wherein photons from said light source are absorbed by said layered catalytic coating, forming a reactive hydroxyl radical that oxidizes said contaminant in the presence of oxygen and water, and said reactive hydroxyl radical oxidizes said contaminants to water and carbon dioxide.

10. The purification system as recited in claim 7 wherein said contaminants are one of a volatile organic compound and a semi-volatile organic compound including at least one of formaldehyde, toluene, propanal, butene, acetaldehyde, aldehyde, ketone, alcohol, aromatic, alkene, and alkane.

11. The purification system as recited in claim 10 wherein said volatile organic compounds have boiling point less than 200° C.

12. The purification system as recited in claim 10 wherein said semi-volatile organic compounds have boiling point equal to or greater than 200° C.

13. The purification system as recited in claim 1 wherein said second layer is metal compound/titanium dioxide including metal oxide on titanium dioxide, and said metal oxide is at least one of WO₃, ZnO, SrTiO₃, Fe₂O₃, V₂O₅, SnO₂, FeTiO₃, PbO, CO₃O₄, NiO, CeO₂, CuO, Sio₂, Al₂O₃, MnxO₂, Cr₂O₃, and ZrO₂.

14. The purification system as recited in claim 1 wherein said second layer is porous.

15. The purification system as recited in claim 1 wherein said second layer is partially transparent to ultraviolet light.

16. The purification system as recited in claim 1 wherein the purification system purifies air.

17. The purification system as recited in claim 1 wherein said first layer is said metal compound/titanium dioxide including metal compound on titanium dioxide and said metal compound is metal oxide.

18. The purification system as recited in claim 1 wherein said second layer is metal compound/titanium dioxide including metal compound on titanium dioxide, and said metal compound is metal oxide.

19. The purification system as recited in claim 1 further including a surface of said substrate, and wherein said first layer is on a portion of said surface of said substrate and said second layer is on a different portion of said surface of said substrate.

20. A fluid purification system comprising:
a container having an inlet and an outlet;
a porous substrate inside said container;
a device for drawing a fluid into said container through said inlet, flowing said fluid through said porous substrate, and expelling said fluid out of said container through said outlet;
a layered catalytic coating including a first layer of one of metal/titanium dioxide and metal oxide/titanium dioxide applied on said substrate and a second layer of one of titanium dioxide and metal oxide/titanium dioxide applied on said first layer; and
an ultraviolet light source to activate said catalytic coating, and photons from said ultraviolet light source are absorbed by said metal/titanium dioxide catalytic coating to form a reactive hydroxyl radical, and said reactive hydroxyl radical oxidizes contaminants in said fluid that are adsorbed onto said metal/titanium dioxide catalytic coating when activated by said light ultraviolet light source to water and carbon dioxide in the presence of water and oxygen.

21. A fluid purification system comprising:
a first substrate having a first coating of one of metal/titanium dioxide and metal oxide/titanium dioxide; and
a second substrate having a second coating of one of titanium dioxide and metal compound/titanium dioxide.

22. The fluid purification system as recited in claim 21 wherein said first coating is gold/titanium dioxide and said second coating is metal oxide doped titanium dioxide.

23. The fluid purification system as recited in claim 22 wherein a metal oxide of said metal oxide doped titanium dioxide is at least one of WO₃, ZnO, SrTiO₃, Fe₂O₃, V₂O₅, SnO₂, FeTiO₃, PbO, CO₃O₄, NiO, CeO₂, CuO, SiO₂, Al₂O₃, MnₓO₂, Cr₂O₃, and ZrO₂

24. The fluid purification system as recited in claim 22 wherein said first substrate is proximate to an inlet of the air purification system and said second substrate is distal to said inlet of said air purification system.

25. The fluid purification system as recited in claim 21 wherein said first coating is manganese oxide/titanium dioxide and said second coating is metal oxide doped titanium dioxide.

26. The fluid purification system as recited in claim 25 wherein a metal oxide of said metal oxide doped titanium dioxide is at least one of WO₃, ZnO, SrTiO₃, Fe₂O₃, V₂O₅, SnO₂, FeTiO₃, PbO, CO₃O₄, NiO, CeO₂, CuO, SiO₂, Al₂O₃, MnxO₂, Cr₂O₃, and ZrO₂

27. The fluid purification system as recited in claim 25 wherein said second substrate is proximate to an inlet of the air purification system and said first substrate is distal to said inlet of said air purification system.

28. The fluid purification system as recited in claim 21 wherein said first substrate is adjacent to said second substrate.

29. The fluid purification system as recited in claim 28 wherein said first substrate is secured to said second substrate.

30. The fluid purification system as recited in claim 29 wherein said first substrate is secured to said second substrate by one of an adhesive or an attachment mechanism.

31. The fluid purification system as recited in claim 28 further including a third substrate having a third coating of one of titanium dioxide, metal/titanium dioxide and metal compound/titanium dioxide and a light source, and first substrate and said second substrate are located on a first side of said light source and said third substrate is located on an opposing second side of said light source.

32. The fluid purification system as recited in claim 31 further including a third substrate having a third coating of one of titanium dioxide, metal/titanium dioxide and metal compound/titanium dioxide and a light source, and first substrate and said second substrate are located on a first side of said light source and said third substrate is located on an opposing second side of said light source.

33. A method of purification comprising the steps of:
applying a layered catalytic coating including a first layer of one of metal/titanium coating and metal oxide/titanium dioxide applied on said substrate and a second layer of one of titanium dioxide and metal oxide/titanium dioxide applied on said first layer;
activating said layered catalytic coating;
forming a reactive hydroxyl radical;
adsorbing contaminants in an air flow onto said layered catalytic coating; and
oxidizing said contaminants with said hydroxyl radical.
